(19) United States
(12) Patent Application Publication
(10) Pub. No.: US 2025/0279954 A1
(43) Pub. Date: Sep. 4, 2025

(54) ROUTE DISTRIBUTION WITH DYNAMIC VLAN MEMBERSHIP FILTERING

(71) Applicant: Arista Networks, Inc., Santa Clara, CA (US)

(72) Inventors: Alton Lo, Fremont, CA (US); Venkitraman Kasiviswanathan, San Ramon, CA (US); Chidambaram Periyakaruppiah, Cupertino, CA (US); Varun Siripurapu, Fremont, CA (US); Pradeep Jothimani, San Jose, CA (US)

(21) Appl. No.: 18/591,910

(22) Filed: Feb. 29, 2024

(51) Int. Cl. H04L 45/02; H04L 45/00; H04L 45/42

(52) U.S. Cl. CPC H04L 45/04; H04L 45/42; H04L 45/566

(57) ABSTRACT

A networking device dynamically manages its routing data according to the particular VLANs associated with locally-accessible devices. The networking device generates route targets based on the active VLANs and uses the VLAN-based route targets to communicate with a route reflector and/or other networking devices. As active VLANs on the local edge networking device change, the edge networking device may locally filter stored routes or change its route target membership with the VLAN-based route targets, enabling the edge networking device to dynamically subscribe and unsubscribe to route information for different VLANs as the currently-active VLANs used by local computing devices change over time. Route advertisements for local devices (e.g., to circulate a MAC address associated with a particular VLAN and its availability at the edge networking device) are circulated with the respective VLAN-based route target, enabling the advertised route advertisement to be matched with the subscribed VLAN members.

### BACKGROUND

This disclosure relates generally to dynamic virtual local area networks (VLANs) and more particularly to coordinating routing information distribution based on VLAN membership.

In typical configurations, networking devices acting as an edge node (i.e., edge networking devices), such as top-of-rack devices, provide routing for a tenant for multiple dynamic VLANs. When a computing device connected to an edge node is assigned an address for a particular VLAN, the computing device is typically permitted to communicate with other computing devices assigned to the same VLAN, which may be dispersed across the network. The networking device then advertises the device address to obtain routes to other computing devices for the tenant in coordination with a route reflector. The route advertisement (e.g., as a border gateway protocol (BGP) request) may include a virtual network interface (VNI) corresponding to the VLAN and route sharing information such as an associated route target. The route sharing information may be used to control import and export of routes across devices. The route reflector coordinates and sends routes to the edge networking devices of the tenant, enabling routing across the network for the tenant's data. Route sharing information is typically statically set for each edge networking device and may be the same for all edge devices. As such, although the actually-instantiated host addresses of an edge node for a particular tenant may belong to a limited number of member VLANs, routes may be sent to the edge node from the route reflector for all other edge nodes. This can result in routes to edge nodes for irrelevant VLANs to be generated, circulated by the route reflector, and stored by the edge nodes.

### BRIEF DESCRIPTION OF THE DRAWINGS

FIG. 1 shows an example networking environment in which networking devices transfer information in a network, according to one embodiment.

FIG. 2 shows example components of a networking device, according to one embodiment.

FIGS. 3A-B shows an example of route management with dynamic VLAN-based route targets, according to one embodiment.

FIG. 4 is an example process for managing routes based on dynamic VLAN membership, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

Rather than statically designating route sharing information, a networking device (e.g., an edge node) dynamically generates values for route targets (i.e., route sharing information) based on the virtual local area network (VLAN) membership of the hosts connected to that edge node. The dynamically-generated route target values may be used to specify filtering for routes to be received by the edge node and in routes distributed by the edge node. As such, rather than statically-setting the route sharing information, the route sharing information is generated (e.g., route target import and export values) based on the member VLANs of an edge node.

Each networking device (e.g., an edge networking device) generates the route targets based on the active member VLANs, such that the route targets can be matched across edge devices and enabling route sharing only for devices with the same active VLAN identifiers. In effect, the route targets used by a particular edge networking device thus implicitly represent the dynamic VLAN membership. Route target membership requests sent to the route reflector may then be used to dynamically provide routes relevant to the currently-active VLANs at the edge device. Active VLANs can be determined based on host authentication with an authentication server and subsequently used to modify route target membership for the device. The route target membership may then change as computing device VLAN membership changes on the edge device. This enables automatic route sharing with the route reflector based on the route information and more efficient route distribution and maintenance, as only routes for active route target memberships (corresponding to the active VLANs) is maintained on each edge device.

### System Environment

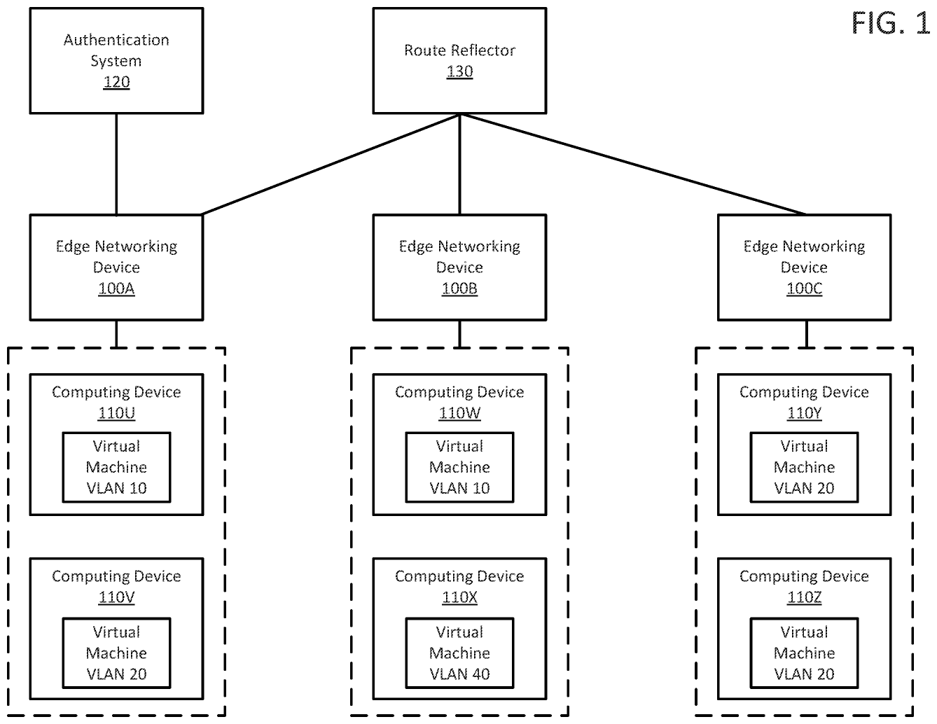

FIG. 1 shows an example networking environment in which networking devices transfer information in a network, according to one embodiment. The networking devices and related processes discussed herein may also be applied to different networking configurations and architectures, such that the particular arrangement shown in FIG. 1 shows one example architecture in which these approaches may be applied. In general, the networking devices, such as edge networking devices 100A-C, provide various network switching and routing services between various computing devices 110U-Z and may provide networking services with L2 and/or L3 network addressing (e.g., including handling with Media Access Control (MAC) and Internet Protocol (IP) addresses). The different computing devices 110 may communicate with packets including a payload for delivery and header information describing various information for handling processing of the packet during network communication, which may include information about the source, destination, sequence information, priority information, data type, and so forth.

In the environment of FIG. 1, each edge networking device 100A-C is connected to one or more computing devices 110U-Z. The connected computing devices 110 of each edge networking device 100 represent the local computing devices for the respective edge networking device. In this example, the computing devices 110U-V are connected locally (i.e., directly) to edge networking device 100A, computing devices 110W-X to edge networking device 100B, and computing devices 110Y-Z to edge networking device 100C. The networking devices (including edge networking device 100, authentication system 120, and route reflector 130), may be configured in various networking architectures, such as a spine and leaf architecture in which each edge networking is a “leaf” device that connects to other leaf devices via a set of spine networking devices (not shown). In some configurations, the route reflector 130 may be one or more of the spine devices in a leaf and spine architecture. Additional networking devices (not shown) may be included in various architectures and provide further switching and forwarding for data between the edge networking devices 100. As another example, the edge networking device 100 may also be a “top-of-rack” device connected to a group of computing devices 110 on a server rack and provides a connection to other devices at other racks in a data center, across different data centers, or across a broader network (e.g., the Internet). The edge networking devices 100 may thus be physically remote from one another (such as edge networking device 100A relative to edge networking device 100C) and accessible via various intermediate communication links and further networking devices.

Each edge networking device 100 provides networking services for communication with other devices across the overall network (e.g., to and from computing devices 110 connected to other edge networking devices 100). For example, edge networking device 100A may receive packets from computing device 110V for delivery to computing device 110Y via edge networking device 100C.

The edge networking devices 100A-C (generally, edge networking device 100) also provide communication between computing devices 110 associated a virtual local area network (VLAN), such that communications within the same VLAN may be designated with link layer (e.g., Layer 2 or “L2”) packets (which may also be termed “data frames”) as though the relevant computing devices were on the same local network. In this example, computing device 110V, Y, and Z are members of the same VLAN, VLAN 20. As such, the computing device 110V may communicate with other computing devices 110Y, Z associated with the same VLAN (e.g., via packets labeled with VLAN 20) as though they were on the same local network (e.g., with link layer addressing) without considering additional details about the network topology, which is handled by the various networking devices, particularly the related edge networking devices 100.

In some embodiments, a computing device 110 is associated with a VLAN in conjunction with an authentication system 120. A computing device 110 may provide credentials for authentication with an authentication system 120 for association with a particular VLAN specified by a VLAN identifier (VID). Authentication by the authentication system 120 may register the respective computing device 110 with the edge networking device 100 in association with a particular VLAN specified by the authentication system 120. In general, computing devices 110 associated with the same VID may then communicate with one another across the network, and typically but not with devices associated with other VIDs. In some embodiments, the computing devices 110 may execute a virtual machine or other virtualized environment that is authenticated and associated with a VLAN. In some instances, individual computing devices 110 may instantiate multiple virtual machines, each of which may be authenticated with a VLAN and may have different VLAN identifiers. A supervisory environment within the computing device 110 may be responsible for managing the VLAN associations of the individual virtual machines and, in some embodiments, assign virtual addresses (e.g., MAC addresses) to the virtual machines. As such, although the discussion herein generally refers to communication by “computing devices” associated with a particular VLAN identifier, in practice, individual computing devices may be authenticated (particularly, individual virtual machines and/or virtual MAC addresses) with different individual VLANs (i.e., different VIDs) and may do so based on particular virtual machines on the computing device 110.

The edge networking devices 100 provide routing/forwarding through the network for link layer packets that specify VLAN information. The link layer packets may also be referred to as data frames and specify addresses according to communication port addresses, which may be referred to as an L2 address, Ethernet address, physical address, or Media Access Control (MAC) address. The data frames may include packets formatted in various ways and may comply with various standards such as IEEE 802.1Q (“Dot1q”). As such, one format for link layer packets for VLAN communication designates a source MAC address, a destination MAC address, and a VLAN identifier (among other possible fields).

When the edge networking device 100 receives a packet designating a VLAN, the packet may be forwarded locally when the destination is locally accessible to the edge networking device or sent to another edge networking device (a destination edge networking device) for delivery. The packet may be forwarded to the destination edge networking device through the network via another protocol, such as with a networking address (e.g., an L3 or an Internet protocol (IP) address) or label-based addressing (e.g., multi-protocol label switching (MPLS)). These further protocols may include encapsulating the packet with additional headers and other information for forwarding the packet within the network to the destination edge networking device. One example protocol for transmitting VLAN-related traffic over Layer 3 addressing is Virtual extensible Local Area Network (VXLAN), which includes a Virtual Network Identifier (VNI) in a VXLAN packet header.

In many instances, the VNI (in the VXLAN packet header) may be the same value as the VID specified in the Layer 2 packet and designate a unique reference to a particular VLAN within the relevant domain and scope. E.g., Layer 2 formatting with a dot1q header may designate a VID with a 12-bit value, while VXLAN formatting at Layer 3 may designate a VNI with a 24-bit field to account for the possible mixture of different, separate groups of VLANs having overlapping VID values (e.g., different prefixes in a VNI may differentiate the same value of a local VID value in Layer 2 data frames at different edge networking devices). For example, a data center or collection of data centers may provide different groups of VLANs for different portions of a customer/tenant's devices across networking devices of a large network, enabling the different VIDs to effectively represent different VLAN namespaces (e.g., for different groups of VLANS or tenants). Depending on the configuration and whether a potential conflict between groups of VIDs is present, the VNI may be determined based on the VID, such as by adding an identifier of a respective namespace, or tenant (e.g., appended to the VID), modifying the VID by a fixed value (e.g., 10000) or may be identical to the VID (e.g., setting the additional bits to zero). For example, in a configuration that adds a fixed value of 10000 to a VID to determine the VNI, a particular VLAN may equivalently be represented as a VID of 10 (VLAN 10) or a VNI of 10010.

Unless separately discussed, identification of a particular VLAN may refer to the VID and/or the corresponding VNI of the VLAN. Thus, to simplify the following discussion, distinct VLANs are generally referred to herein with respect to separate VIDs (e.g., the approximately 4k values available in a 12-bit VID field of a dot1q header), although similar principles may apply to contexts in which different groups of VIDs are used (e.g., for different tenants of a data center).

As such, one edge networking device may encapsulate a VLAN packet received from a local computing device and encapsulate the packet for transport to a destination edge networking device. At the destination edge networking device 100, the additional headers may be removed for the packet to be sent locally as a link layer data frame (e.g., with the original data frame). As such, the edge networking devices 100 may “tunnel” the link layer frames for a VLAN through the network for delivery locally as a link layer packet by the destination networking device. In some circumstances, the edge networking devices 100 operates as a VXLAN tunnel endpoint (VTEP), providing entry and exit of VLAN packets to the VXLAN L3 architecture.

Over time, different computing devices 110 may be associated with VLANs, such that the particular VLANs (e.g., VIDs) currently being used with a particular edge networking device 100 may dynamically change over time. For example, different computing devices 110 may be active at different times or may instantiate different virtual machines to perform different functions at different times, which may be associated with different VIDs. As such, the particular VIDs that are relevant to a particular edge networking device 100 may dynamically change over time. As discussed further below, the edge networking devices 100 may automatically maintain and/or prune forwarding/routing information based on the VLANs currently active locally at the edge networking device 100.

The edge networking devices 100A-C may also communicate with a route reflector 130 that coordinates distribution of VLAN-related information to the edge network devices, enabling effective route distribution. Although one route reflector 130 is shown in FIG. 1, multiple route reflectors may be used in various embodiments, and the route reflector may itself provide networking services as a part of the network. For example, in some configurations the route reflector 130 may operate as a spine device in a leaf and spine architecture. The route reflector 130 provides a central location for gathering and distributing information about VLAN membership and network routing. The route reflector 130 may gather and distribute information for forwarding packets by the edge networking devices 100, such as available MAC addresses for computing devices on respective VLANs and associated network addresses for the edge networking device connected to the computing device.

The route reflector 130 may use route targets to determine the distribution of VLAN-related routes for the edge networking devices 100. When information about devices accessible by an edge networking device is advertised, the associated route target is used to determine which networking devices should receive that advertisement. As discussed further below, the edge networking devices generate route targets based on the VLAN membership of the local edge networking devices, which may dynamically change over time. By specifying route targets based on VLAN membership, the distributed routes across the network dynamically account for these changes and enable distribution and maintenance of routes in the network without excess route information advertised to or stored by edge networking devices.

For example, in FIG. 1, the computing devices associated with edge networking device 100A are associated with VLANs 10 and 20, edge networking device 100B with VLANs 10 and 40, and edge networking device 100C with VLAN 20. Each edge networking device may request routes for route targets (e.g., route target membership) based on the respective VLANs. As such, the route target generated by edge networking device 100A based on VLAN 10 (associated with computing device 110U) may match the route target separately generated by edge networking device 100B based on VLAN 10 (associated with computing device 110W), enabling distribution of routes by the route reflector 130 based on VLAN membership for each edge networking device 100. Because edge networking device 100B designates route targets based on VLANs 10 and 40, it may similarly not receive routes associated with computing devices 110V, Y, Z associated with VLAN 20 (and route targets based on VLAN 20). In addition to aiding distribution of the relevant routes, the dynamic VLAN-based route target also enables more efficient communication of routes by reducing communication of unnecessary routes (e.g., routes related to VLAN 20 are not distributed to edge networking device 100B). As discussed further below, as when VLANs become active or inactive on an edge networking device 100, the route target membership may be dynamically changed, enabling circulation of relevant routes by the route reflector 130 and pruning/maintenance by the respective edge networking devices 100.

### Networking Device

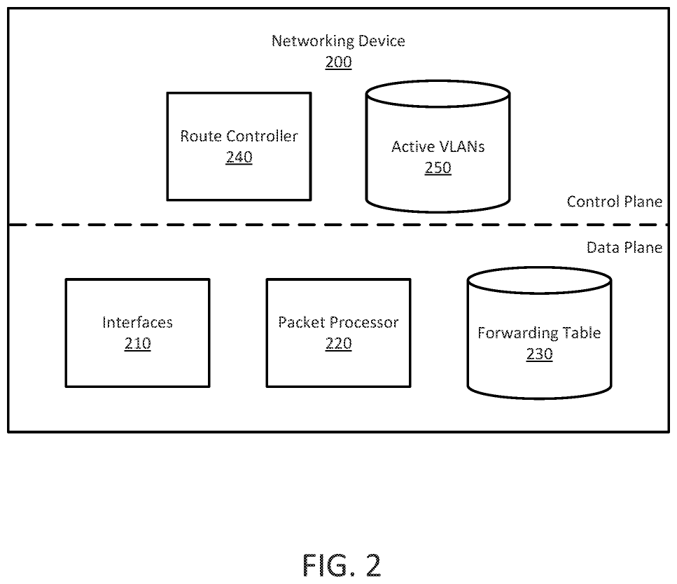

FIG. 2 shows example components of a networking device 200, according to one embodiment. The networking device 200 may be implementations of the networking devices shown in FIG. 1, such as the edge networking devices 100A-C. The various components shown in FIG. 2 are generally discussed with respect to their functional behavior, such that various implementations may separate the discussed functionality into additional components or further combine the functionality to fewer components than discussed herein. In addition, in many instances, the discussed components are implemented in hardware circuits, registers, memories, processing circuits, and so forth, and thus may include application-specific circuits, programmable circuits, as well as general-purpose processors (that operate on instructions in a memory, such as a non-transitory computer-readable medium) for performing the discussed functions.

The networking device 200 includes a number of interfaces 210 for receiving and sending packets. Packets received at an interface 210 are processed by a packet processor 220 according to entries in a forwarding table 230. In some embodiments, received packets may also be filtered, at the interface 210 or by another component (such as a packet processor 220), for example, to retain packets that are addressed to the networking device 200 and discard packets that are not addressed to the networking device 200. This filtering may be based, for example, on hardware-level addresses such as a Media Access Control (MAC) address associated with the networking device 200 or its interfaces 210.

The packet processor 220 inspects the packets and applies appropriate processing for sending each packet to a subsequent networking device (i.e., a “next hop” device). In addition to determining the particular interface 210 to which the packet is to be sent, the packet processor 220 may also modify a packet's headers to modify addressing of the packet and apply other information that may be used by subsequent devices to process the packet. As one example, the MAC address in the packet header may be modified to rewrite the destination MAC address in the packet from the MAC address of the networking device 200 to a MAC address of the subsequent device for the packet in the network. As discussed above, for link layer packets specifying a VLAN, the packet may be encapsulated with additional headers (e.g., specifying a VNI, MPLS label, and/or IP address(s)) for transport in the underlying network to a destination edge networking device. After processing, the packet may be sent to the designated physical interface 210, which sends the packet along the corresponding physical connection for receipt by the subsequent networking device. Though not shown here, the networking device 200 may include further buffers and queues for managing the packets at different stages, such as before processing by the packet processor 220, a queue for transmission by each interface 210, and so forth.

The packet processor 220 processes each packet according to information in a forwarding table 230. The forwarding table 230 provides information for modifying the packet, such as by modifying packet headers and designating an interface for egress of the packet. With respect to packets specifying a VLAN, the packet processor 220 may look up a corresponding entry based on the designated VLAN (e.g., the VID field of a link layer packet) and specified the link layer addresses (e.g., the source or destination MAC addresses). In some instances, the source MAC address and VID are checked to confirm that the source MAC address is authenticated to use the VID. Next, the destination MAC and VID may be looked up to identify processing to the destination MAC. When a corresponding entry exists in the forwarding table 230, it specifies handling for the packet, such as a local interface for the destination MAC address for that VLAN or the destination IP address for another edge networking device associated with the destination MAC address for that VID. The forwarding table 230 in this configuration may operate in a “VLAN Aware Bundle Service” in which entries are identified by a combination of VID and MAC address.

For VLAN packets being sent to another networking device for delivery (i.e., to a destination IP address), the packet may then be forwarded according to the destination IP address of the destination edge networking device (e.g., by identifying a subsequent device in the network towards the destination IP address (i.e., a next hop device) and forwarding the packet to the subsequent device). Similarly, when packets are received from other networking devices that specify the networking device 200 as the destination for VLAN-related traffic, the networking device 200 may remove applicable headers and forward the packet locally according to the encapsulated packet (e.g., according to the VLAN and destination MAC address). The packet processor 220 and forwarding table 230 may thus be considered a “data plane” and are generally configured to optimize throughput for processing packets for which the type of processing is known (i.e., specified in the forwarding table 230).

The networking device 200 also includes a route controller 240 that coordinates control of the networking device 200, such as updates to the forwarding table 230 and represents a “control plane” that may operate in conjunction with control-related processes on other devices. The route controller 240 may perform and implement additional types of control for the networking device 200 in addition to managing the forwarding table 230. In general, the route controller 240 organizes and determines operation of the data plane of the networking device 200, determining the various parameters for operating the packet processing of the networking device 200. As such, the route controller 240 may perform various route-finding tasks, and in some embodiments, may coordinate with controllers at other networking devices to determine and implement routes to destination addresses. As such, the route controller 240 may coordinate authentication of devices with particular VLANs (e.g., in conjunction with an authentication system 120 as shown in FIG. 1) and manage entries mapping MAC addresses and VLAN membership to parameters for transmission to a destination edge device. That is, the route controller 240 may include entries authenticating local devices (e.g., related to source MAC addresses and the labeled VLANs in the packet) along with entries for sending packets to the destination MAC addresses on the VLAN. To send packets to other networking devices (e.g., where a destination MAC address on the VLAN is accessible by another edge networking device), the entry may specify an MPLS label for a packet or provide MAC-IP mapping to a destination network address for the destination MAC (e.g., associating destination MAC addresses for a particular VLAN with a particular IP address of a destination edge networking device). The route controller 240 may also coordinate entries in the forwarding table 230 for forwarding the packets based on any of the added headers (e.g., next hop entries for destination IP addresses and/or MPLS labels).

To manage VLAN-related information, the route controller 240 may maintain a set of active VLANs 250 indicating the current VLANs that are locally active for the networking device 200. The set of active VLANs may specify the particular devices and/or MAC addresses associated with particular VLANs that are currently used by the local computing devices. The active VLANs 250 thus represent the set of VLANs for which the networking device 200 will obtain and store VLAN-related forwarding information in the forwarding table 230 (e.g., MAC-IP or MPLS mappings). For an edge networking device as shown in FIG. 1, the active VLANs 250 may indicate the set of associated local computing devices/MAC addresses and authenticated VLAN memberships. As devices are associated with VLANs or the active VLANs change, the route controller 240 may generate a route target based on the VLAN and notify a route reflector to advertise the available MAC address on the VLAN or to modify the route targets associated with the networking device 200, such that the networking device 200 may receive and apply routes only associated with the active VLANs 250.

### Route Targets

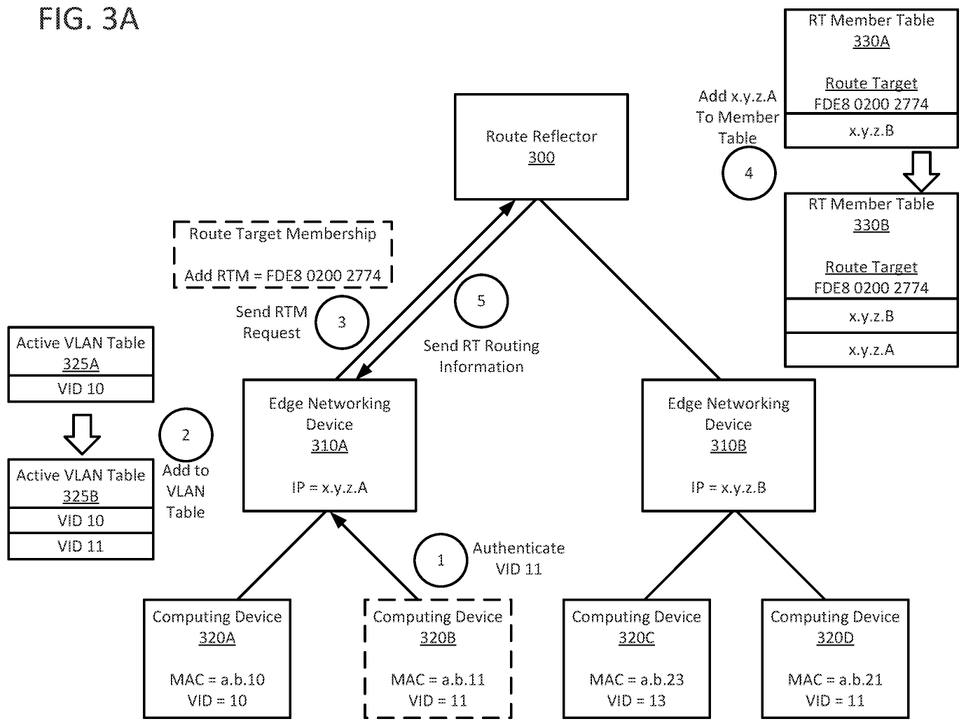

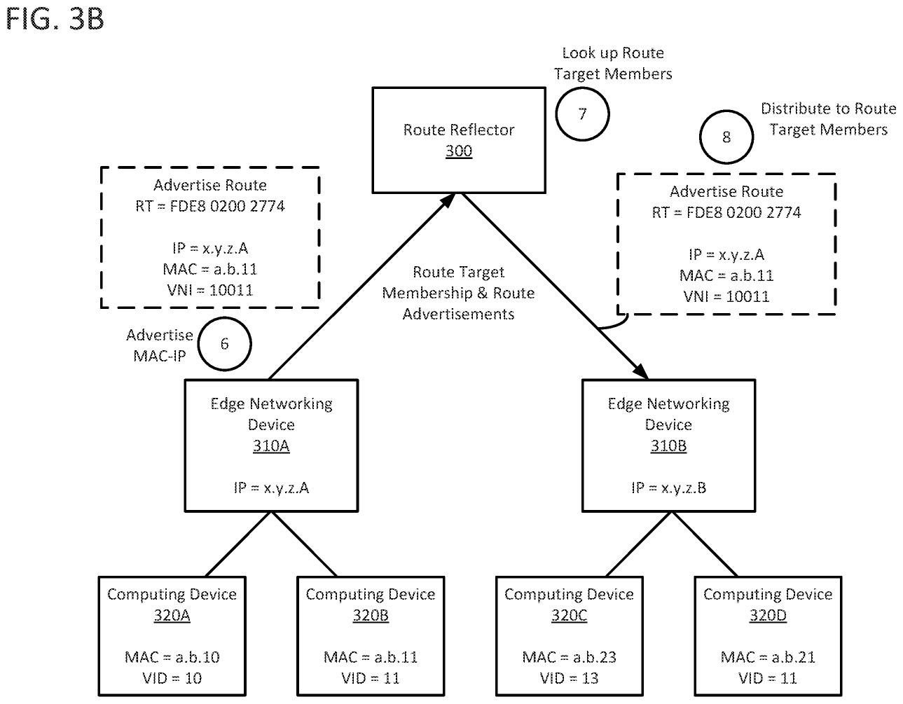

FIGS. 3A-B shows an example of route management with dynamic VLAN-based route targets, according to one embodiment. The environment of FIG. 3A-B is similar to FIG. 1 but simplified to show two edge networking devices 310A, B with respective computing devices 320A-D. In the example discussed below for FIGS. 3A-B, computing devices 320A, C, D are initially associated with respective VLANs as indicated (computing device 320A with VID 10, computing device 320C with VID 13, and computing device 320D with VID 11), and FIGS. 3A-B show network processing and messaging for the addition of computing device 320B to VID 11 accessible to edge networking device 310A. In this example, the edge networking devices 310 communicate with a route reflector 300 to coordinate distribution of routes across the network.

The route reflector 300 coordinates distribution of information about VLAN membership, such as MAC addresses for particular VLANS accessible at each edge networking device 310. The route reflector 300 provides a central location for circulating information about accessible MAC addresses and reduces flooding of VLAN information across edge networking devices 310. The route reflector may proactively distribute accessibility and/or routing information (e.g., MAC-IP mapping or MPLS labels) for the different VLANS as information about accessible MAC addresses is received (e.g., based on advertised information from the edge networking devices 310). In the example of FIGS. 3A-B, MAC-IP mapping is shown, although other protocols for routing/mapping may also be used (e.g., MPLS) as discussed above.

The distribution of VLAN information is based on a “route target,” for example, as used by border gateway protocol (BGP) and in corresponding BGP requests. The route reflector 300 includes a list of route targets and associated networking devices (e.g., edge networking devices 310A-B) subscribed to receive information for each route target. The value of a route target is used to match advertised information to requested information, such that an associated route target of advertised information is distributed to devices subscribed to that route target. The devices subscribed to the route target may be described as “members.” A “route target” is used herein to refer to a value for distributing VLAN availability information (e.g., by matching a route target value of advertised information to subscribers of that route target value) as it may be used in different protocols and does not necessarily require the use of a particular protocol, such as BGP, for coordinating that distribution. The route reflector 300 may store the members for a particular route target according to network address (e.g., IP) in a table. As discussed below, a route target (RT) membership table may be updated to add or remove members according to the received route targets.

An edge networking device 310 provides a “route target membership” (RTM) request to be added or removed from membership of particular route targets. To dynamically manage routes and route-related traffic with respect to the VLANs, a route target may be automatically generated by the edge networking devices 310 that is based on the relevant VLAN (e.g., based on a VID or VNI). As discussed in the example below, the route targets may be generated for the active VLANs of the edge networking device and used to send route target membership requests that specify route targets based on the active VLANs. The value of the route target may be deterministically generated by the edge networking device, such that the same route target value is generated for the same VLAN (e.g., VID 10) by different edge networking devices (but differs for different VLANs), enabling the active VLANs to be described in the route target value. Because information is typically distributed by the route reflector 300 based on route targets, basing the value of the route target on the relevant VLAN enables the route reflector 300 to continue to route based on the route targets, and in some cases, may not require explicit knowledge by the route reflector 300 of the active VLANs accessible on particular edge networking devices 310. However, in some embodiments, the route reflector 300 may manage distribution of VLAN information as discussed below based on VLAN membership similar to the route target values discussed below.

FIG. 3A shows an example of updating route target membership when active VLAN membership changes at the edge networking device 310A when computing device 320B authenticates membership with VLAN identifier (VID) 11. In the initial state of FIG. 3A, a route target (RT) member table 330A (stored by the route reflector 300) shows the membership for a route target (FDE8 0200 2774) corresponding to VLAN 11 and having an IP address for edge networking device 310B, corresponding to active VLAN 11 at the edge networking device 310B. Additional RT member tables may be maintained by the route reflector 300 for route targets associated with the other active VLANs (e.g., VID 10 and 13). Likewise, the initial state of the edge networking device 310A may include an active VLAN for VID 10 associated with a MAC address of computing device 320A; the edge networking device 310B may include active VLANs for VIDs 11 and 13 associated with the respective MAC addresses of computing devices 320C, D.

The computing device 320B may instantiate a virtual machine or other environment that is authenticated with a VLAN for a particular MAC address, e.g., with a dot1x authentication system as discussed above, indicated as step 1 in FIG. 3A. After authentication, the edge networking device 310A adds the authenticated MAC address of computing device 320B to its list of authenticated devices for VID 11 and adds an entry in its forwarding table mapping the MAC address to VID 11 to the respective local interface. As discussed below with respect to FIG. 3B, the MAC address, its associated VID, and accessibility via edge networking device 310A, is advertised to the route reflector 300.

The edge networking device 310A determines whether the authentication of VID 11 modifies the active VLANs accessible at edge networking device 310A. The edge networking device 310A may compare the authenticated VLAN (i.e., VID 11) with an active VLAN table 325A. In this example, edge networking device 310A previously had active VID 10 only and VID 11 is added to the active VLANs of edge networking device 310A. VID 11 is added to active VLAN table 325B, indicated as step 2 in FIG. 3A. As the edge networking device 310A previously did not have VID 11 active, the edge networking device 310A does not have MAC-IP mapping information related to MAC addresses for VID 11. To obtain these routes, the edge networking device 310A generates a route target based on the added VID (here, VID 11) and includes the route target in a route target membership request sent to the route reflector 300, indicated as step 3 in FIG. 3A and discussed further below. In this example, the route target for VID 11 has a value of FDE8 0200 2744, and as discussed above, may be deterministically generated by edge networking devices 310, such that the generated route targets align for the same VLAN across devices.

### VLAN-Based Route Targets

The value of the route target based on a particular VLAN may be determined in a variety of ways depending on the configuration of the edge networking devices 310. In general, in addition to being determinable by different edge networking devices 310, the route target should be distinguishable for different VLANs within the relevant environment without conflicting with networking devices (e.g., that may use the same route reflector 300 or jointly use edge networking devices 310 with devices on a VLAN). Depending on the complexity of the environment, the route targets may thus need to avoid conflict with other tenants, address spaces, and so forth. The route target may be generated based on a VID specified at the address layer or may be generated based on a corresponding VNI as discussed above. In some circumstances, a correspondence of VLAN to route targets may be pre-specified or statically determined, for example as a table. In other circumstances, the route target may be determined by including the VID or VNI in a field (or portion thereof) for generating the route target.

In some embodiments, the route target may include fields specifying a local administrator (e.g., an Autonomous System Number (ASN)), an encapsulation type (e.g., VXLAN or MPLS), and an identifier for the VLAN (e.g., a VNI or VID). The route target may also include field(s) for designating whether the route target is automatically or manually derived, an address space, and/or domain identifier. When the route target includes a field for the local administrator, in some embodiments, it may be modified to enable the same route target value across different administrators. When the edge networking devices 310 are iBGP peering (and have the same ASN), the ASN of the local administrator may be used in the local administrator field. When the edge networking devices 310 are eBGP peering, the local ASN may differ for different edge networking devices 310. In this instance, the local administrator field of the route target may instead use a specified or static value, such as 65000, enabling the resulting route target to match across systems.

In some circumstances, a route distinguisher (RD) is also determined for use with the route target. The route distinguisher may be determined based on an address of the networking router and a VLAN identifier or based on a value for an associated virtual routing and forwarding (VRF) identifier of the VLAN. To avoid conflicts with other types of VLAN configurations (e.g., VLAN-based MAC-VRF), in some embodiments, the VRF identifier for a VLAN-aware bundle is generated by padding the VRF identifier (of a VLAN-aware bundle configuration) by the size of the space for other VLAN configurations, for example by padding with 12 bits corresponding to a 4k VLAN space of a VLAN-based MAC-VRF.

### Route Target Membership

After generating the route target, the edge networking device 310A may generate a route target membership request to subscribe to (e.g., import) information related to the route target. The route target membership message may comply with various protocols in different embodiments; in one embodiment, the route target membership message is a VXLAN BGP message. The route target membership request is sent to the route reflector 300, indicated as step 3 in FIG. 3A. The route reflector may then update the RT member table 330A for the corresponding route target to include the edge networking device 310A in the RT member table 330B, indicated as step 4 in FIG. 3A. The route reflector 300 may also create and/or circulate relevant routing data for the added edge networking device 310A, for example, by sending existing mapping data such as MAC-IP mappings or MPLS information, for reaching MAC addresses accessible via other devices and the relevant VNI/VID. The sent routing information from the route reflector 300 for the joined route target is shown as step 5 in FIG. 3A. This data may then be stored in the receiving device's forwarding table (here, edge networking device 310A) for processing packets for that particular VLAN. As such, the route target membership is used to designate the VLAN-related routing/forwarding information to be imported to the edge networking device 310. As discussed below with respect to FIG. 3B, edge networking device 310A may also send route information to the route reflector 330 indicating availability of computing device 320B on VID 11.

In the example of FIG. 3A, after adding the route target membership for edge networking device 310A to the corresponding route target member table 330, the route reflector 300 circulates MAC-IP mapping for reaching relevant MAC addresses for that route target. The route reflector 300 stores MAC-IP mappings for other devices associated with the route target, in this example associated with VID 11 and including computing device 320D. Route information is distributed to edge networking device 310A for reaching advertised routes associated with the route target, in this case the MAC address (a.b.21) of the VLAN (i.e., VID 11 or corresponding VNI) associated with computing device 320D via an IP address (x.y.z.B) of its associated edge networking device 310B. The relevant mapping data may include information for entry in the edge networking device 310A's forwarding table, such as a relevant VNI. As such, by sending a route target membership request with the VLAN-based route target when VID 11 is added at edge networking device 310A, the relevant routes can be dynamically shared with the edge networking device 310A for the active VLANs of the edge networking device 310A.

Stated another way, the edge networking device 310A identifies the added VID 11 at step 2 as a newly-active VLAN, generates a route target based on the VLAN identifier and sends a route target membership request at step 3 to receive related routes at step 5. As the active VLAN table 325 did not previously include VID 11, the edge networking device 310A did not maintain related routes, enabling the edge networking device to dynamically maintain (and prune) routing information as the active VLAN identifiers change over time.

### Route Advertisement

In addition to importing the relevant routes for the VLAN, the edge networking device 310A may also advertise availability of addresses on its active VLANs. The edge networking devices 310 may thus send route advertisements to publicize reachability information for local devices on respective VLANs. When devices are deactivated (i.e., no longer associated with the VLAN), the edge networking devices 310 may also send a message to remove entries related to the deactivated device. Information about available devices may be sent as route advertisement messages, for example as MAC-IP route advertisements for IP-based routing. As such, the route advertisements and associated route target provide for “exporting” reachability information to other devices subscribed to the same route target. FIG. 3A discussed above discusses updating the route target membership for “importing” route information (i.e., what route targets are subscribed to), while FIG. 3B discussed below discusses “exporting” route information to be used by subscribed devices (routes to be received by subscribed devices).

The example of FIG. 3B continues the example of FIG. 3A and may be performed sequentially (before or after) or in parallel to the route target membership update discussed with respect to FIG. 3A. After the MAC address of computing device 320B is authenticated (step 1 in FIG. 5A), in addition to updating route target membership (i.e., the route targets subscribed to by the edge networking device 310A), the edge networking device 310A also notifies other devices that the MAC address can be reached via the edge networking device 310A. The edge networking device 310A assembles a route advertisement request, specifying the route target (FDE8 0200 2774) for the VLAN as discussed above and relevant information for reaching the authenticated device, such as its MAC address (a.b.11), IP address (x.y.z.A) of the edge networking device 310, and the related VNI (10011). The route advertisement request is shown as step 6 in FIG. 5B. The edge networking device 310A sends a MAC-IP route advertisement to the route reflector 300 for distribution to relevant route target members.

The route reflector 300 receives the MAC-IP route advertisement, looks up route target members for the specified route target, shown as step 7, and distributes the route advertisement to the route target members, shown as step 8, in this case to edge networking device 310B. To look up relevant route target members, the route reflector 300 accesses a route target membership table 330 (as shown in FIG. 3A) for the route target of the advertised route. In this example, the route reflector 300 identifies the route membership table corresponding to a route target of FDE8 0200 2774 and identifies the subscribed members. As shown in FIG. 3A, the subscribed members in the route target member table 330B are IP addresses x.y.z.A and x.y.z.B corresponding to edge networking devices 310A-B. As the route was received from edge networking device 310A, the route may be distributed to the other subscribed members (step 8), in this case to IP address x.y.z.B corresponding to edge networking device 310B. In addition to circulating the advertised route to subscribed members, the route reflector may also store the route at the route reflector 300.

The edge networking device 310B may now store the MAC-IP mapping for the VLAN its respective forwarding table. By coordinating the route distribution according to VLAN membership through route targets, the route reflector may optimize route distribution across edge networking devices 310 without requiring static definition of device VLAN membership. Rather, as edge networking devices add and remove active VLANs and particular MAC addresses associated with VLANs, the route target membership can be automatically adjusted to effectively distribute information to relevant edge networking devices 310. This enables the edge networking devices 310 to automatically manage route target memberships without user intervention and reduce unnecessary route distribution.

### Dynamic VLAN-Based Route Targets

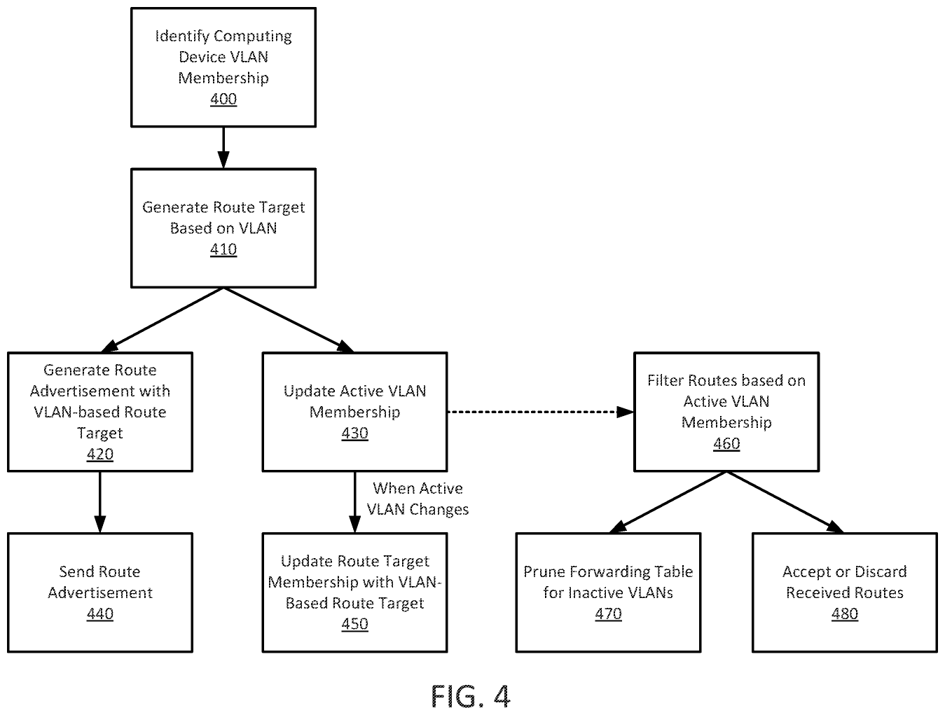

FIG. 4 is an example process for managing routes based on dynamic VLAN membership, according to one embodiment. The example process of FIG. 4 may be performed, e.g., by a networking device such as an edge networking device as discussed above, for example, by components of a control plane and/or data plane of networking device 200 such as route controller 240 in conjunction with active VLANs 250 and forwarding table 230.

Initially, the networking device may identify 400 a computing device associated with a VLAN, for which a change should be made with respect to the active VLANs or the related associated devices/MAC addresses. The identified device is typically a local device for which the networking device operates as an edge networking device for connection to other networking devices, at which other associated devices (e.g., MAC addresses) are reachable for the VLAN. As discussed above, although computing devices may generate packets received by the networking devices, the VLANs may be managed by the networking device 200 with respect to particular MAC addresses (or other link layer addresses) that originate or receive packets at the computing device. As such, though “computing device” may be used for convenience, in practice, the “computing device” may be represented by the MAC address in association with the VLAN membership, rather than an express device-level association. An identified computing device and related VLAN membership may be the addition of a computing device to a VLAN, such as after authentication of a device with an authentication system. Similarly, the identified computing device may be a device that is no longer active on the network, such that the device should be removed from relevant tables. In some embodiments, the networking device identifies computing devices (and associated VLAN) for removal after a period of inactivity or if the computing device fails to authenticate. In some circumstances, the computing device may be required to authenticate periodically (e.g., every hour) to maintain authentication with the VLAN. As such, the current computing devices/MAC addresses associated with each VLAN may be periodically reviewed for aging activity and removed when sufficiently aged.

After identifying 400 a relevant computing device, the networking device may generate 410 a route target for transmission of route advertisements and/or to update the VLAN membership and circulate a route target membership request. The route target for a VLAN may be generated 410 based on the VLAN identifier, such as a VID or a VNI of the VLAN as discussed above. When a route target has already been generated 410 for the relevant VLAN, the route target may be retrieved rather than re-generating the route target. When the identified device is added or removed from the local networking device, a route advertisement is generated 420 that includes the VLAN-based route target along with relevant information for the device and the related VLAN; the route advertisement is sent 440 to relevant devices, such as a route reflector as discussed above.

Similarly, in addition to updating other devices regarding accessible addresses for respective VLANs at the networking device, the device may manage its routes by updating 430 the active VLAN membership. The VLAN membership may then be used to update, when necessary, route target membership and locally-stored routes. When the active VLANs are changed by the computing device VLAN membership, such as the first device becoming active for a particular VLAN identifier or removing the last device for a VLAN, the active VLANs are modified accordingly (i.e., to add or remove the VLAN). When the active VLANs change, the route target membership is also changed, such that the routes of interest to the device may include or exclude the relevant VLAN. The route target membership is updated 450 with the route reflector to add or remove route target membership for the VLAN-based route target of the respective VLAN.

Finally, the active VLANs are used to filter 460 routes that may be stored at the local networking device. When routes are received for active VLANs (and relevant route targets), the routes may be accepted 480 and stored in the forwarding table; received routes for VLAN identifiers that are not active are instead discarded. Similarly, stored routes in the forwarding table may be pruned 470 for inactive VLANs, for example when a VLAN transitions from active to inactive.

Accordingly, the local networking device can dynamically manage the stored routes and effectively signal with a route reflector member according to the VLANs that are currently active at the local device. In addition, by incorporating the VLAN information into route targets with dynamic route target membership changes, distributed routes can be more effective and reduce overhead both on distributed routes and also on routes maintained at edge networking devices.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A networking device for dynamic route management of a virtual local network (VLAN), comprising:
a route controller configured to:
determine that a computing device connected to the networking device is associated with a VLAN having a VLAN identifier:
determine that the VLAN identifier is not included in a set of active VLAN identifiers;
determine a VLAN-based route target based on the VLAN identifier; and
responsive to determining that the VLAN identifier is not included in the set of active VLAN identifiers:
generate a route target membership request with the VLAN-based route target, the route target membership request indicating the networking device requests routes related to the VLAN-based route target; and
send the route target membership request to a route reflector to receive routes associated with the VLAN identifier.

2. The networking device of claim 1, wherein the route controller is further configured to determine that the VLAN identifier is inactive for computing devices local to the networking device and send another route target membership request to stop receiving routes associated with the VLAN identifier.

3. The networking device of claim 2, wherein the route controller is further configured to remove stored routes for the VLAN identifier when the VLAN identifier is inactive.

4. The networking device of claim 1, wherein the route controller is further configured to receive a route for the VLAN identifier from the route reflector and store the route in a forwarding table.

5. The networking device of claim 1, wherein the route controller is further configured to:
generate a route advertisement for the computing device including the VLAN-based route target; and
send the route advertisement to the route reflector.

6. The networking device of claim 5, wherein the route advertisement is a border gateway protocol (BGP) request.

7. The networking device of claim 1, wherein the route controller determines that the computing device is associated with the VLAN based on authentication of the computing device with an authentication server that provides the VLAN identifier for the computing device.

8. The networking device of claim 1, further comprising a packet processor configured to receive VLAN packets from the computing device and forward the VLAN packets according to received routes from the route reflector.

9. A networking device for dynamic route management of a virtual local network (VLAN), comprising:
a route controller configured to:
determine that a computing device connected to the networking device is associated with a VLAN having a VLAN identifier in a set of active VLAN identifiers:
responsive to determining that the computing device is associated with the VLAN, determine a VLAN-based route target based on the VLAN identifier;
generate a route advertisement for the computing device including the VLAN-based route target; and
send the route advertisement to the route reflector.

10. The networking device of claim 9, wherein the route advertisement is a MAC-IP route advertisement.

11. The networking device of claim 9, wherein the route advertisement is a border gateway protocol (BGP) request.

12. The networking device of claim 9, wherein determining that the computing device is associated with the VLAN is based on authentication of the computing device with an authentication server that provides the VLAN identifier for the computing device.

13. A method, performed by a networking device, for dynamic route management of a virtual local area network (VLAN), comprising:
determining a computing device connected to the networking device is associated with a VLAN having a VLAN identifier:
determining the VLAN identifier is not included in a set of active VLAN identifiers;
determining a VLAN-based route target based on the VLAN identifier; and
responsive to determining the VLAN identifier is not included in the set of active VLAN identifiers:
generating a route target membership request with the VLAN-based route target, the route target membership request indicating the networking device requests routes related to the VLAN-based route target; and
sending the route target membership request to a route reflector to receive routes associated with the VLAN identifier.

14. The method of claim 13, further comprising determining that the VLAN identifier is inactive for computing devices local to the networking device and sending another route target membership request to stop receiving routes associated with the VLAN identifier.

15. The method of claim 14, further comprising removing stored routes for the VLAN identifier when the VLAN identifier is inactive.

16. The method of claim 13, further comprising receiving a route for the VLAN identifier from the route reflector and storing the route in a forwarding table.

17. The method of claim 14, further comprising:
generating a route advertisement for the computing device including the VLAN-based route target; and
sending the route advertisement to the route reflector.

18. The method of claim 17, wherein the route advertisement is a border gateway protocol (BGP) request.

19. The method of claim 13, wherein determining that the computing device is associated with the VLAN is based on authentication of the computing device with an authentication server that provides the VLAN identifier for the computing device.

20. The method of claim 13, further comprising receiving VLAN packets from the computing device and forwarding the VLAN packets according to received routes from the route reflector.
